(19) United States
(12) Patent Application Publication
(10) Pub. No.: US 2016/0193515 A1
(43) Pub. Date: Jul. 7, 2016

(54) LIGHT TRACK PACING SYSTEM

(71) Applicant: Alexandra Macomber Kline, Anacortes, WA (US)

(72) Inventor: Alexandra Macomber Kline, Anacortes, WA (US)

(21) Appl. No.: 14/828,863

(22) Filed: Aug. 18, 2015

Related U.S. Application Data
(60) Provisional application No. 62/100,329, filed on Jan. 6, 2015.

(51) Int. Cl. A63B 69/00; H05B 33/08; H05B 37/02

(52) U.S. Cl. CPC A63B 69/00; A63B 69/0028; H05B 37/029; H05B 37/0281; H05B 33/0842

(57) ABSTRACT

An visual light track with LED lights coupled with a controller and software provides a pacing system for athletes. The system uses an LED light strip containing closely spaced LED lights that sequentially light up at a given rate input by the user who can then chase the light in order to maintain a target running pace.

### RELATED APPLICATIONS

This application claims priority to U.S. provisional application Serial No. 62/100329 filed on Jan. 6, 2015, the entire contents of which is incorporated herein for all legal purposes.

### FIELD OF THE INVENTION

The invention relates generally to a device disposed on or along a track to provide visual aid including desired speed and desired position to an athlete progressing through said track.

### BACKGROUND

The statements in this section merely provide background information related to the present disclosure and may not constitute prior art.

Athletes routinely train on predefined courses, be they lanes in a pool, lanes on a track, or other playing field. Athletes want to maximize benefits of training by practicing at a competitive pace. During actual sports events, the pace may be set by competitors. But in training, an athlete is typically training in semi-isolation and there is no convenient system to provide the athlete with an indication of his progress.

U.S. Pat. No. 6,086,379 describes a training system and method used to improve the biomechanics, distance per stroke, and aerobic metabolism of a swimmer. The system employs a computer interface which allows a coach or a swimmer to input a particular training strategy using pace lights and timing system or, alternatively, using the system's internal training program. The system provides a generator to collect data from a swimmer. A part of the training system is designed to automate the data collection routine while operating in tandem with a swim meter. Another part of the system analyses the swimmers' performance and outputs the appropriate data to the pace light controlling circuitry.

U.S. Pat. No. 1,675,972 discloses a system that will entice hounds to chase a predetermined course for the purpose of racing or training The system discloses a mechanism to propel a lure for the hounds around an enclosed track.

U.S. Pat. No. 6,283,612 describes a light emitting diode light strip that uses a rigid hollow tube sized to accommodate a printed circuit board which has a positive and negative bus extending the full length of the board. One or more resistors are in contact with the positive bus on one end and a series of light emitting diodes on the other. The diodes are mounted through holes in the board and the anode of the diode is in communication with a resistor while the cathode of the diode contacts an adjacent diode anode connecting them in linked series through traces on the bottom of the circuit board. The end cathode in each series, engages the negative bus forming a predetermined group of diodes electrically coupled to a single resistor on one end and the negative bus on the other. A pair of end caps enclose the tube and an electrical cable is connected through the caps to the busses on the circuit board. A power supply is in contact, through the electrical cable, with the board providing low voltage direct current power through the busses to a predetermined group of light emitting diodes, for illumination of the area surrounding the light strip.

U.S. Pat. No. 5,748,981 A describes an architecture for a single chip microcontroller wherein the microcode stored in the microcontroller's program memory may be easily modified without re-fabrication or removal of the microcontroller from its target environment. This is made possible by the utilization of a RAM based architecture for program memory instead of the traditional ROM based architecture.

U.S. pat. app. No. 13/265369 describes a system for light signaling to supply a moving light reference to an athlete, said system including a plurality of lighting elements, in particular light emitting diodes, arranged along an athlete path, e.g., a floating lane divider of a swimming pool, controlling means adapted to control said plurality of lighting elements according to a lighting sequence adapted to generate said moving light reference and to impart to said moving light reference a displacement speed along said plurality of lighting elements which is settable through said controlling means. According to the invention, said system further comprises a plurality of microcontrollers arranged in a cascaded connection with respect to command signals pertaining lighting parameters sent by said controlling means and arranged along said athlete path, said microcontrollers being connected to respective sets of lighting elements in said plurality of lighting elements to command their lighting state on the basis of said command signals.

Some GPS watches provide pacing feedback, but they are impossible to read while running hard. Further, the watch itself may be incompatible with the environment (water), or the act of reading the watch may itself interfere with the training

### SUMMARY OF THE INVENTION

While the invention is described in terms of running, the invention in alternative embodiments also includes swimmers, walkers, bikers, or other such sports where athletes run a pre-determined course. A first embodiment of the invention includes a system that employs an interface on a personal device by which pace lights for runners or other athletes can be controlled. The system comprises a controller, a series of lights, for example LEDs, which are disposed on, alongside, or above a predetermined course, and is connectable to an interface on a personal device such as a laptop, phone, or tablet that allows the user to input a training strategy using pace lights. Such system would allow a coach or a runner to program individual training sessions to more closely control desired training speed and as a result improve performance. Lights are controlled to sequentially cascade, giving an appearance of continuous motion. Generally, a moving pace signal will have a plurality, for example five or ten or twenty, lights immediately adjacent to one another be lit according to the programmed pace parameters. In such a configuration, having lights individually lighting one at a time immediately ahead of the pace signal and going off one after another at the same time from the back of the pace signal will result in a visual impression of continuous movement.

Advantageously a plurality number lights are spaced at a distance such that the eye of the athlete perceives a substantially fluid, rather than discontinuous motion, with the purpose of providing not only the pace, but a comparison of the travelling speed. Lights may be spaced as little as one per inch or less to one per five feet or more, preferably no further than one foot apart. The controller can control lights individually or can control a duration of light time, where lights cascade. One or more lights can be lit at any time. Generally, lights are lit ahead of the runner, for example about 0.2 to 2 seconds ahead of the runner, so the runner does not need to look down at his or her feet to see the signaling elements.

Another embodiment of the invention includes the system of the first embodiment and also includes separate audio, physical, and/or visual signaling if the runner is exceeding the pre-set pace, and by how much a runner may be exceeding a pre-determined pace or an actual pace being run (or ridden on a horse or motor vehicle, or swam, or biked). One drawback to the first embodiment is if the runner is exceeding the pace the lights from the first embodiment may not be readily visible, being behind the runner or close to the feet of the runner. Trying to see these lights in this condition would hinder performance. This second embodiment would therefore include a signal to the runner indicating how far ahead of the desired pace the runner is at. The signal may be a different set of lights, perhaps of different color, disposed in the light track. One simplest system would be to have two sets of light tracks, a primary one indicating the pace where the runner should be, and a second track projecting a given amount of time, say five seconds or some other increment of time the runner is not expected to cut off of the desired pace, said second light track lighting ahead of the primary light track providing the desired pace. The runner could estimate how far ahead of the projected pace he or she is at if the primary light track is not visible. A signal could also be projected to LEDs in eyewear, which show either by the number or frequency of the eyepiece lights how far ahead of pace the athlete may be. Or the signal may be audio, for example a noise signal transmitted to an earbud signaling to the athlete by frequency or amplitude how far ahead of the projected pace the runner may be. Of course, to indicate how far ahead of the desired pace the runner is at, the system must be able to determine the position of the runner. This is readily achieved by Radio Frequency Identification chips and sensors, photoelectric sensors, or other means known to those skilled in the art. This position would be transmitted to the controller and be used by the controller to provide the runner a signal, or to provide another runner a signal.

Another embodiment includes the invention of the first and or second embodiments above, and also includes visual signaling of the position of another “virtual runner” on a separate path. For example, the speed and or position, typically the position, of another athlete who has run the same or similar course, can be projected on a separate light track. Again, if the runner is ahead of the virtual runner, an audio or visual signal can be generated to indicate to the runner how far ahead he or she may be. This leads to the embodiment of providing a virtual race, for example between the runner on the light track and one or more people who are running a similar course which is removed from the first course. Again, the key is to provide a signal so that if a runner is ahead of the other runner, the distance or time he or she is ahead can be indicated by audio or visual means. The runner who is behind can readily see how far behind he is, but in preferred embodiments the runner who is ahead knows approximately how far ahead (in distance or in time) that he or she may be. The position of said runners on the separate paths would be measured in any way known in the art, for example by Radio Frequency Identification chips and sensors, photoelectric sensors, or other means known to those skilled in the art. This allows for a “virtual meet,” where an athlete competes against another athlete running a similar but physically distant route at the same time, the progress of each runner being monitored by the respective controllers, and shown to the other runner as a light signal.

The present invention solves the above current disadvantages whereby competitive and recreational runners, cyclists, and swimmers struggle to maintain a target pace during workouts and currently have no easy-to-see visual feedback on their pace. Lack of real-time, easy-to-see pace feedback makes it difficult for athletes to maintain a target pace and thereby makes their workouts less effective.

The invention includes the described systems and use thereof. Use of various controller algorithms and cascading light series is within the skill of one of ordinary skill in the art.

The TrackPacer™ LED light strip, which includes the first embodiment of the invention, is a system of lights disposed along a predetermined pathway or course to indicate the desired position and speed to an athlete moving through the pathway or course, and the lights indicate to the athlete whether he is maintaining his target pace. In one embodiment there are no other visual non-worn pace indicators. Presently, athletes rely on watches or other worn devices to monitor their pace, which for example rely on GPS or such. The LED light strip indicator is better than existing methods because it eliminates monitoring a watch or worn device and permits even a sprinter to determine whether he is maintaining target pace.

The TrackPacer™ is superior to sports watches due to its convenient, easily viewed placement, for example on the inner perimeter of a track, or other location where the athlete can obtain visual feedback without having to make un-natural movements, e.g., look up at clock, look at watch, or the like.

### DETAILED DESCRIPTION OF THE INVENTION

The LED light strip contains closely spaced LED lights that sequentially light up at a given, but controller variable, rate input by the user. The user can input their desired pace into the TrackPacer™ application that can be downloaded onto their phone. The application on the user's phone is connected by Bluetooth to for example an Arduino microcontroller that sends electronic signals to the light strip. The sequentially lighting LEDs appear as a traveling light throughout the TrackPacer™ for the athlete to chase. The TrackPacer™ application's interface will allow the user to preset their desired pace for each lap or fraction thereof in either miles/hour, time (i.e. a meet or world record time) for a given race distance, or sec/lap or min/miles. For example, a user could enter in that they want to run four laps at 75 seconds per lap (300 seconds total), or alternatively a first lap in 68 seconds, second and third laps at 79 seconds each, first half of fourth lap in 39 seconds and final half lap at 35 seconds (300 seconds total). Once the user has set their pace, they would then push a “GO” button. Once the “GO” button is pushed, the application's interface advantageously visually and audibly counts down 5-4-3-2-1-GO at which point the user knows to begin running

This invention is an improvement on what currently exists. Currently, an athlete can only check if they are on pace once a lap by using a watch to check splits. However, watches cannot show if an athlete is falling behind or getting ahead during the lap. The TrackPacer™ provides a continuous indicator of pace during the entirety of the lap. Essentially, it provides continuous feedback, on every point of the track rather than once or twice a lap.

This LED light pace signal eliminates the trouble of mentally calculating splits, and gives the athlete a more reliable training method. It's convenient, easily viewed placement on the inner perimeter of a track provides instant feedback without a need for the athlete to make any mental calculations. Worn devices hinder performance due to their weight, added drag, and difficulty of reading whilst moving. A radio frequency identifier, mentioned for some embodiments, are commercially available in sizes and weights so small that the effect on athletes are minimal. Simple glasses or earbuds, used in other embodiments, also have only a small effect on athlete performance.

One embodiment of the Invention includes: 1) LED light strip of sufficient length to extend around the inner or outer perimeter or along a length of a track; 2) a weatherproof or protected channel affixed to the track to contain LED strip; 3) a smartphone, computer, tablet, or input device containing applications for inputting desired paces and distances; 4) a controller, for example an Arduino microcontroller to send the electronic signals to the light strip; 5) advantageously a Bluetooth Low Energy Shield (BLE 4.0) to link application interface to the Arduino; and advantageously a weatherproof container to house Arduino and Bluetooth Shield located at the track. In some embodiments other types of lights are use, for example regular incandescent light.

In more complex embodiments, the LED light strip may contain Radio Frequency Identification sensors, photoelectric sensors, or other means known to those skilled in the art for the controller or interface to monitor the runner's position. Radio Frequency Identification chips, which are cheap and light-weight, can be worn by the athlete without the athlete being even slightly impeded.

As stated, advantageously the pace lights are lit sufficiently forward of the athlete so that the athlete can monitor progress without unduly looking down or to the side. One issue is what happens when a runner is ahead of the pace. In this case, in the simplest embodiment, the runner would receive no signal. In this instance, a visual signal can be provided by a second light track, typically of different intensity and/or color than the primary light track. This secondary light could be extended for example several seconds ahead of the desired pace/position. Alternatively is a single series of light track is used, the pace may be continuously lit but for example a number of single lights could be lit, for example where the light track has a light every 2 inches, a single light may be illuminated for example five feet ahead of the pace, ten feet ahead of the pace, and fifteen feet ahead of the pace. Different spacing and number of “leading lights” can be used for different races, as will be apparent to a trainer. For example, if three individual leading lights are illuminated at 5, 10, and 15 feet ahead of the closely spaced primary pace lights, then if the runner can only see one leading light, then the runner knows he or she is about ten feet ahead of the position indicated by the desired or input pace. Alternatively, an audio signal can indicate how much a runner is ahead of pace.

In one embodiment the interface for the TrackPacer™ is linked to the programmable controller, e.g., a Arduino microcontroller through for example the Bluetooth Shield. A user's input into the interface is transmitted through Bluetooth to the Arduino, which then sends electronic signals to the programmable LED light strip. The electronic signals to the light strip regulate the color, distance, and rate at which the LEDs will light up. The Arduino microcontroller and Bluetooth Shield will advantageously be located in the weatherproof box at the track. The LED light strip is connected to the Arduino microcontroller by one ground wire, one clock wire, and one data wire. The LED strip and wires may be enclosed in a waterproof enclosure, such as a clear plastic tube, to minimize water issues. A fourth wire is connected to the power supply. A BLE Shield 4.0 device establishes a Bluetooth connection between a user's phone, computer, or tablet to the Arduino. Through this Bluetooth connection, the interface transmits a signal to the Arduino which then sends an electronic signal to the programmable LED strip causing the lights in it to light up at the correct rate as prescribed by the user via the interface on their phone, computer, or tablet. The sequentially lighting LEDs appear as a traveling light throughout the strip for the athlete to chase. The TrackPacer interface will allow the user to preset designated distances, paces, and rest intervals.

To make a simplest embodiment of the system, install the LED light strip around the inner (or outer, or center, so long as the track is readily visible but does not interfere with the runner) perimeter of track by emplacing it inside a weatherproof channel at the inner perimeter of the track. Connect the light strip into the Arduino. Connect the BLE Shield 4.0 to the Arduino. Connect the LED strip into a 12V power supply and connect the Arduino into a 9V power supply. Download the TrackPacer™ application from the Apple App Store or from Google Play depending on the type of device used. Such an application will allow a runner to input pace criteria. Turn on Bluetooth and establish a connection with the TrackPacer™.

Possible additions to the TrackPacer include additional light strips embedded into each lane of a track in order for someone in each lane to use, or to indicate the position where a competitor is expected to be. A single runner can run a race against one or more virtual competitors. Different colors of LEDs could be used simultaneously for different paces and workouts so that multiple users doing different workouts could both use the TrackPacer at the same time. The LED light strip can be applied to other sports such as swimming where it could be placed in the bottom of the pool for swimmers to pace themselves. The light strip could also be laid along other kinds of courses, such as obstacle courses, 5k or even marathon courses.

The invention also encompasses the use of the system, to train, and to run virtual meets. A user enters a desired pace into the interface and chases the moving light as the LEDs sequentially light up at the prescribed pace. In some embodiments an audio signals is used in addition to light signals, for example to notify the runner how far ahead of the pre-selected pace the runner may be at any given time. The pace be variable, as in for initial push, long term race, and final sprint. A second series of lights/audio/LED can be run to indicate, for example by blinking or beeping, when it is time to accelerate/slow down, and a sensor to allow the controller to monitor the position versus time for the runner. This position indication can be simple radio frequency identification chips or antenna, along with appropriately spaced sensors. Such a system will allow the athlete to do an after-training review of the race, identifying areas where the runner exceeded or did not meet expected goals.

Certain systems will be more desirable in certain locations. For example, use in pools and indoor pools should have the system in a redundant robust waterproof enclosure, for example housed in a continuous length of cleat plastic, e.g., tygon, tubing. The tubing can be sealed or can be adapted to circulate air to facilitate drying of electronics. Use of low voltage

LED versus regular lights is beneficial for safety. Spacing of lights in the light track, that is, the continuous series of lights, connecting wires, secondary controllers or cascading controllers, and the like, can be continuous (realistically one light per inch or even per three inches would be viewed as continuous), one light per foot or per meter, one per five meters, or other distances which make sense based on the length of the course and the speed of the athlete. The light strips having an LED approximately every 3 centimeters are readily available, and the light appears continuous when it's moving along at even a slow running speed.

Two users may use the same light track, where signals for a first user are one color, e.g., blue, and signals for a second user can be a second color, e.g., blue. Such light tracks are readily manufactured by one of skill in those arts.

In some embodiments, use of focusing apparatus (like the reflective parabola on a flashlight) and opaque sides will be incorporated into the light track to allow use of very low intensity lights that can be visible to the athlete but will not to interfere with others on different lanes of the track or course. In some embodiments, light would be of particular wavelength or polarization and the athlete would wear specific glasses to allow the user to only see his or her light track. For example, an athlete wearing customized eyewear, for example glasses allowing horizontally orientated light to pass there-through, would see the signal on a light track providing that signal. A runner in the next track, wearing for example glasses allowing vertically orientated light to pass there-through, would not see the light from the first light track, but could see signals from a second light track, providing the second light track puts out vertically polarized light. Use of this or of focusing/blocking means will prevent a track having multiple lanes from becoming a mishmash of confusing signals.

The invention is intended to be illustrated by but not limited to the specific examples disclosed. The examples disclosed for the LEDs, programmable controllers or microcontrollers, and the like are meant to be illustrative and are items readily obtained at reasonable commercial cost.

What is claimed:

1. A device for pacing an athlete, comprising:
a. a pacing system disposed in spaced apart relation to the athlete such that a pacing signal indication is perceptible to the athlete while moving along a pre-determined course, wherein the pacing system comprises a plurality of pacing light elements disposed along the course followed by the athlete, and a primary pacing signal indication comprises a plurality of activated pacing light elements that form a subset of the total pacing light elements; and
b. a controller adapted to control said pacing light elements according to a lighting sequence adapted to generate a moving pacing signal indication and to impart to said moving pacing signal indication a predetermined displacement speed or position along said course, and
c. an interface connection adapted to be connectable to a personal electron device that is used to input a training pace.

2. The device of claim 1, wherein the plurality of pacing light elements are controlled to sequentially cascade, giving an appearance of continuous motion of the pacing signal indication.

3. The device of claim 3, wherein the plurality of pacing light elements comprising the pacing signal indication are controlled to sequentially cascade, giving an appearance of continuous motion of the pacing signal indication.

4. The device of claim 1, wherein the device further comprises a detector to detect the position of the athlete, and a device to inform the athlete via an audio signal, a physical signal, a visual signal, or combination thereof, relating to how much a runner may be exceeding the predetermined displacement speed or position, wherein the controller determines the athletes position on the course, compares the position with the predetermined displacement speed or position along said course, and send said signal to the athlete.

5. The device of claim 4, wherein the detector to detect the position of the athlete comprises a plurality of Radio Frequency Identification sensors disposed along the course and a Radio Frequency Identification chip attached to the athlete.

6. The device of claim 4, wherein the visual signal to inform the athlete relating to how much a runner may be exceeding the predetermined displacement speed or position comprises at least one other moving pacing signal indication, said other moving pacing signal indication being distinguishable from the primary pacing signal indication.

7. The device of claim 1, wherein there are a plurality of pacing systems located along the course and a plurality of athletes, and the device further includes means to make a primary pacing signal indication be visible to a first athlete but not be visible to a second athlete.

8. The device of claim 4, wherein the controller is connectable to another controller at a separate location, and the primary pacing signal indication represents the position and speed of a second athlete running a course at said separate location.

9. A method of training an athlete, said method comprising having the athlete complete a course following the primary pacing signal indication from the device of claim 1.

10. The method of training an athlete of claim 9, wherein the pacing lights comprising the pacing signal indication are lit at a distance between about 0.2 to 2 seconds ahead of the desired pace at the current displacement speed.

11. The method of training an athlete, said method comprising having the athlete complete a course following the primary pacing signal indication from the device of claim 4.

12. A system for training a runner, comprising;
a. a pacing system disposed in spaced apart relation to the runner such that a pacing indicator is perceptible to the runner while running, wherein the pacing system is a plurality of pacing lights disposed along a running path followed by the runner, the pacing indication corresponding to a predetermined running velocity;
b. a control system capable of activating the signal emitter to produce the signal and capable of activating the pacing system to provide the pacing indication, the control system controlling the signal and the pacing indication according to a predetermined running pace;
c. a detector to detect the position of the athlete along the course; and
d. a device to inform the athlete via an audio signal, a physical signal, a visual signal, or combination thereof, how much a runner may be exceeding the predetermined displacement speed or position, wherein the control system determines the athletes position on the course, compares the position with the predetermined displacement speed or position along said course, and send said audio signal, physical signal, visual signal, or combination thereof to the athlete.
